(19) United States
(12) Patent Application Publication
(10) Pub. No.: US 2026/0134110 A1
(43) Pub. Date: May 14, 2026

(54) METHOD FOR CONSTRUCTING A BACKTRACKING ANALYSIS MODEL BASED ON AN ATTACK CHAIN

(71) Applicant: Huaneng Information Technology Co., Ltd., Qingdao (CN)

(72) Inventors: Lei Cui, Qingdao (CN); Shuo Han, Qingdao (CN); Sheng Ye, Qingdao (CN); Hao Guo, Qingdao (CN); Wenwei Liu, Qingdao (CN); Cheng Fan, Qingdao (CN); Yubao Zhou, Qingdao (CN); Shouhui Xin, Qingdao (CN); Huanxiu Ding, Qingdao (CN); Wei Li, Qingdao (CN)

(73) Assignee: Huaneng Information Technology Co., Ltd., Qingdao (CN)

(21) Appl. No.: 19/281,526

(22) Filed: Jul. 25, 2025

(30) Foreign Application Priority Data
Jun. 26, 2025 (CN) CN202510875287.0

(51) Int. Cl. G06F 21/57; G06F 21/53; G06F 21/55; G06N 3/006; G06N 5/01; G06N 7/01

(52) U.S. Cl. CPC G06F 21/577; G06F 21/53; G06F 21/554; G06N 3/006; G06N 5/01; G06N 7/01

(57) ABSTRACT

Provided is a method for constructing a backtracking analysis model based on an attack chain, including: a kernel-layer security agent collects process, file, and network behavior features in a hardware-isolated environment to generate event tuples; a tensor network pipeline performs three-dimensional decoupling mapping of the tuples into behavior fingerprint vectors, orthogonalized noise features, and asymmetric adjacency tensors, and compresses them into spatio-temporal topological tensor block; a reinforcement learning controller constructs a directed acyclic graph based on the tensor block, calculates connectivity loss, and outputs event risk scores; a dynamic routing engine constructs a decision tree model based on risk markers, burst frequency, and correlation entropy to implement three-level shunting, and a multi-simulation system generates anti-interference index; when the deviation between a physical trajectory and a digital model exceeds a tolerance, a closed-loop feedback weight coefficient is used to updates loss function parameters and adjust channel resource weights.

### CROSS-REFERENCE TO RELATED APPLICATIONS

This application claims priority of Chinese Patent Application No. 202510875287.0, filed on Jun. 26, 2025, the contents of which are hereby incorporated by reference.

### TECHNICAL FIELD

The present disclosure relates to the field of data processing technology, and particularly to a method for constructing a backtracking analysis model based on an attack chain.

### BACKGROUND

A backtracking analysis model based on an attack chain is a network security event response technology that reconstructs a complete attack process through reverse deduction of a sequence of attack events. Starting from known attack consequences, such as system damage or data leakage, the model systematically collects and analyzes security logs, network traffic data, and event evidence to deduce the timing relationships and path dependencies of intrusion behaviors. The logical reasoning process integrates timestamp consistency, event correlation, and context information to derive the initial access points, lateral movement paths, and target execution steps in the attack chain step by step, thereby identifying weak links in security such as configuration errors or unpatched vulnerabilities. The final result supports security teams in optimizing defense strategies and improving active detection and response capabilities.

In the backtracking analysis model based on an attack chain, a technical pain point of insufficient performance in processing massive security events exists in real-time generation and updating of attack chains. This is specifically manifested as: when a network intrusion detection system generates tens of thousands of security event records per second, including Windows security audit logs, Linux syslog records, and application-layer access logs, existing analysis engines cannot efficiently complete event filtering and key behavior feature extraction. For example, in a scenario where a cloud server cluster is subjected to large-scale brute-force cracking attacks, the number of SSH authentication failure logs surges to 200,000 within one minute. Due to limitations in computing resources, an event correlation engine is forced to enable a sampling mechanism, resulting in the erroneous discarding of some low-frequency high-risk events, such as abnormal login of administrator accounts, destroying the continuous deduction of the attack chain and delaying the identification timeliness of the lateral movement attack stage.

### SUMMARY

Aiming at the deficiencies of the prior art, the present disclosure provides a method for constructing a backtracking analysis model based on an attack chain, to solve the problem of delayed threat behavior discovery caused by attack chain breakage under the impact of massive security events.

To solve the above technical problem, the present disclosure is specifically as follows:

The method for constructing a backtracking analysis model based on an attach chain provided by the present disclosure includes:
Step 1: capturing process creation behaviors, file access behaviors, and network connection behaviors through a security agent deployed in a host kernel layer, and generating event tuples;
Step 2: inputting the event tuples into a tensor network processing pipeline, through three-dimensional tensor space mapping, encoding behavior fingerprints as 0th-order vectors, orthogonalizing noise feature vectors for filling to a 1st order, converting causal dependency chains into adjacency tensors for storage in a 2nd order, performing tensor chain dimensionality reduction compression driven by a matrix product state model, retaining low-rank hidden variable subspaces with singular values exceeding a preset threshold, synchronously calculating clock offsets of slave nodes with a phase of a master node as a reference via virtual quantum clocks, applying phase rotation operations to generate a clock-generated synchronized event sequence, and integrating them into a time dimension of a low-rank tensor block to form an attack behavior tensor block retaining a spatio-temporal topology;
Step 3: inputting the attack behavior tensor block through a reinforcement learning controller, modeling a current attack chain as a directed acyclic graph with security events as nodes and attack stage transition probabilities as edges, and outputting an event importance score vector marking privileged credential access nodes;
Step 4: receiving a risk-marked sampled event set through a dynamic routing engine, constructing a gradient boosting decision tree model to analyze event burst frequency and correlation entropy, assigning events to a genetic path optimization channel when the burst frequency exceeds a first threshold, assigning events to a Bayesian inference channel when the correlation entropy is lower than a second threshold, and assigning events to an ant colony completion channel when the events satisfy neither that the burst frequency exceeds the first threshold nor that the correlation entropy is lower than the second threshold;
Step 5: performing the following on attack chain fragments output by a parallel inference space through a multi-simulation verification system: physically replaying in a container cluster to generate a process behavior heat report, calculating instruction flow offsets and memory dirty data ratios based on system call baseline templates and outputting digital anomaly vectors, deploying a generative adversarial network to inject camouflaged attack events and generating an adversarial robustness score; and fusing the heat report, anomaly vectors, and robustness score through a meta-verifier to generate a comprehensive anti-interference index; and
Step 6: detecting a deviation between a physical replay and a digital model in the comprehensive anti-interference index, generating a weight adjustment coefficient γ when the deviation exceeds a preset tolerance, feeding back γ to the reinforcement learning controller in a closed loop to dynamically update loss function parameters, and feeding back γ to the dynamic routing engine to adjust a channel weight allocation strategy.

Further, in the method for constructing a backtracking analysis model based on an attack chain of the present disclosure, said generating event tuples includes:
through the security agent, intercepting system call behaviors in a hardware-isolated environment, and extracting original features of the process creation behaviors, file access behaviors, and network connection behaviors;
in a differential privacy engine of the security agent, injecting differential noise into the original features according to a preset event type sensitivity matrix, and performing atomic operations for feature extraction and noise injection;
simultaneously retaining process parent-child relationship chains and file handle inheritance relationships in a process of noise injection to construct topology chains explicitly encoding attack causal dependencies; and
integrating noise-processed feature vectors, behavior fingerprints, and topology chains to generate structured event tuples including causal dependency chains.

Further, in the method for constructing a backtracking analysis model based on an attack chain of the present disclosure, generating the low-rank tensor block includes:
receiving an input data stream from the event tuples in the tensor network processing pipeline;
performing tensor space mapping operations to: encode the behavior fingerprints in the event tuples as 0th-order vectors of a tensor, process the noise feature vectors in the event tuples by Gram-Schmidt orthogonalization for filling to the 1st order, and convert the causal dependency chains in the event tuples into asymmetric adjacency tensors for storage in the 2nd order;
constructing a three-dimensional core tensor structure, where three orders of the three-dimensional core tensor structure respectively carry behavior type features, noise distribution attributes, and attack causal weights; and

decomposing the three-dimensional core tensor structure through a matrix product state model in the tensor network processing pipeline, and retaining the hidden variable subspaces with the singular values exceeding the preset threshold to generate the low-rank tensor block carrying spatio-temporal invariants.

Further, in the method for constructing a backtracking analysis model based on an attack chain of the present disclosure, the Step 2 includes:
receiving to-be-corrected event timestamp sequences in the event tuples through a time correction module;
calculating the offsets of clocks of the slave nodes relative to the master node with a clock of the master node as a phase reference through a quantum phase estimation algorithm;
invoking the virtual quantum clocks to apply the phase rotation operations to the clocks of the slave nodes, and generating the synchronized event sequence eliminating clock drift;
inputting the synchronized event sequence into a low-rank tensor block construction process, and integrating time dimension attributes of the synchronized event sequence into time-axis coordinates of the hidden variable subspaces.

Further, in the method for constructing a backtracking analysis model based on an attack chain of the present disclosure, the Step 3 includes:
inputting the low-rank tensor block into the reinforcement learning controller;
in the reinforcement learning controller, modeling the current attack chain as the directed acyclic graph with the security events as the nodes and the attack stage transition probabilities as the edges based on time dimension attributes of the low-rank tensor block;
calculating a connectivity loss value of event discarding operations to attack chain topology integrity, where the connectivity loss value L is quantified by a formula: L=1−(key path node retention rate×edge association strength), and the key path node retention rate is extracted from spatial dimension data of the low-rank tensor block; and
outputting the event importance score vector that generates high-risk markers for the privileged credential access nodes as a basis for constructing the risk-marked sampled event set.

Further, in the method for constructing a backtracking analysis model based on an attack chain of the present disclosure, the Step 4 includes:
continuously monitoring tactical phase transition states of the security events in the reinforcement learning controller, and identifying stage jump events by comparing MITRE ATT&CK tactical labels in the attack behavior tensor block;
activating a feature reconstruction module to load corresponding time period events from an originally captured data stream of the host kernel layer when a stage jump is detected and privileged node-related events marked by the event importance score vector are missing;
processing the loaded events through a feature reconstruction algorithm to generate a reconstructed subset including markers for high-risk privileged nodes; and
merging the reconstructed subset with a current sampled event set to generate an updated sampled event set with dynamic risk markers for outputting to the dynamic routing engine.

Further, in the method for constructing a backtracking analysis model based on an attack chain of the present disclosure, the Step 4 further includes:
receiving the updated sampled event set with dynamic risk markers through the dynamic routing engine;
constructing the gradient boosting decision tree model in the dynamic routing engine, taking risk marker features, event burst frequency, and correlation entropy in the updated sampled event set as input features;
calculating event allocation weights through the decision tree model to: assign events to the genetic path optimization channel when the event burst frequency exceeds a first preset threshold, assign events to the Bayesian inference channel when the event correlation entropy is lower than a second preset threshold, and weight events according to risk marking levels and assign the events to the ant colony completion channel when the events satisfy neither that the burst frequency exceeds the first threshold nor that the correlation entropy is lower than the second threshold; and
outputting classified three types of event sets to corresponding channels of the parallel inference space.

Further, in the method for constructing a backtracking analysis model based on an attack chain of the present disclosure, the Step 5 includes:
receiving the classified three types of event sets output by the dynamic routing engine;
inputting the three types of event sets into the Bayesian inference channel, genetic path optimization channel, and ant colony completion channel for processing, respectively, generating path hypothesis fragments, and storing them in a shared memory pool;
activating the generative adversarial network to complete topological breakpoints in the path hypothesis fragments when inter-channel path consistency is lower than 90%; and
applying the completed path hypothesis fragments to generate an attack chain graph marked with optimization trajectories of each channel for outputting to the multi-simulation verification system.

Further, in the method for constructing a backtracking analysis model based on an attack chain of the present disclosure, the Step 5 further includes:
receiving the attack chain graph through the multi-simulation verification system;
replaying an attack sequence in the attack chain graph in a container cluster, and generating the heat report by recording process behavior trajectories via kernel probes;
collecting instruction flow sequences during replay based on the system call baseline templates, calculating instruction flow Hamming distance offsets and memory page dirty data ratios, and outputting digital behavior anomaly index vectors;
deploying the generative adversarial network to inject temporally correlated camouflaged events into a replay system, and generating the adversarial robustness score based on misjudgment probability of a discriminant network for context semantics; and
fusing the heat report, anomaly index vectors, and robustness score through the meta-verifier to generate the comprehensive anti-interference index for outputting to a deviation correction module.

Further, in the method for constructing a backtracking analysis model based on an attack chain of the present disclosure, the Step 6 includes:
fusing the process behavior heat report, digital behavior anomaly index vectors, and adversarial robustness score through the meta-verifier to generate the comprehensive anti-interference index;
detecting deviations between physical replay heat trajectories and digital model prediction trajectories based on three-dimensional verification data in the comprehensive anti-interference index;
generating the weight adjustment coefficient γ as a dynamic tuning factor when the deviations exceeds a preset tolerance threshold; and
feeding back γ to the reinforcement learning controller in a closed loop to update connectivity loss function parameters, and simultaneously feeding back γ to the dynamic routing engine to adjust the channel weight allocation strategy.

The beneficial technical effects of the present disclosure:
in the present disclosure, original behavior data is collected through the security agent deployed in the hardware-isolated environment, and noise perturbations are injected under the premise of maintaining the causal dependencies of the attack chain in combination with a differential privacy mechanism, thereby mitigating the risk of privacy leakage during sensitive data collection; tensor network three-dimensional feature decoupling and matrix product state dimensionality reduction compression technologies are employed to map high-dimensional event streams to the low-rank hidden variable subspaces, still completely retaining the spatio-temporal topological structure of attack paths at a thousandfold data compression ratio, and breaking through the technical bottleneck of key node loss caused by existing dimensionality reduction methods; a directed acyclic graph model is constructed based on the reinforcement learning controller to quantify the connectivity loss of event discarding to topological integrity, and a three-level event shunting strategy is implemented in combination with the gradient boosting decision tree of the dynamic routing engine, thereby enabling priority processing of high-frequency attack events and privileged operations under limited computing power; and through the multi-simulation verification system, the attack chain is physically replayed and digital behavior anomaly detection are fused to generate the comprehensive anti-interference index to drive a closed-loop feedback mechanism, thereby dynamically adjusting loss function parameters and channel resource allocation weights to continuously correct model deviations, significantly improving the timeliness and integrity of attack chain backtracking analysis under massive event impacts.

### BRIEF DESCRIPTION OF THE DRAWINGS

In order to explain the present disclosure more clearly, the drawings required to be used in the embodiments will be briefly introduced below. Apparently, for those of ordinary skill in the art, other drawings can be obtained according to the drawings without creative efforts.

FIG. 1 is a flow chart of a method for constructing a backtracking analysis model based on an attack chain provided by an embodiment of the present disclosure.

### DETAILED DESCRIPTION OF THE EMBODIMENTS

To make the objectives, technical solutions, and advantages of the present disclosure clearer, the present disclosure will be described clearly and completely in combination with specific embodiments of the present disclosure and the corresponding drawings. Obviously, the described embodiments are only a part of the embodiments of the present disclosure, rather than all of them. All other embodiments obtained by those of ordinary skill in the art based on the embodiments of the present disclosure without creative efforts shall fall within the protection scope of the present disclosure. The technical solutions provided by the embodiments of the present disclosure are described in detail below in combination with the drawings. For a better understanding of the objectives of the present disclosure, the present disclosure is described in further detail as follows.

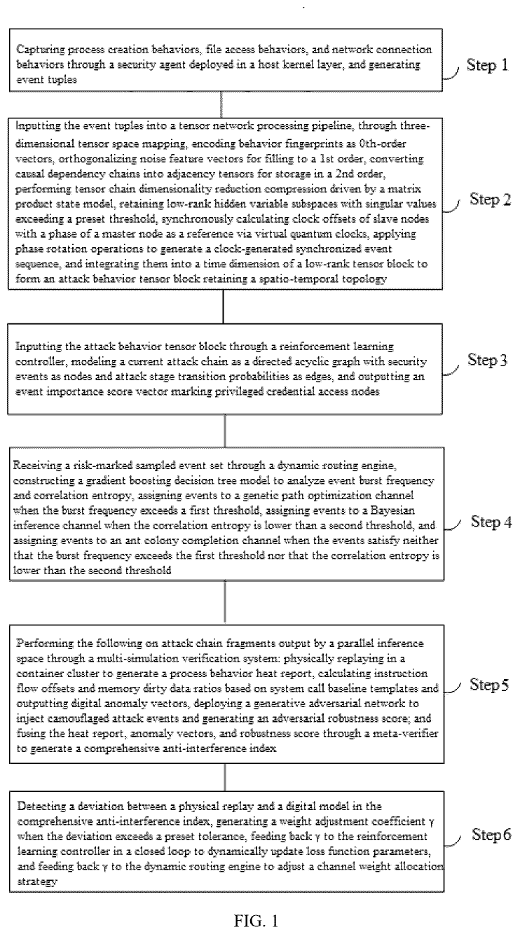

Referring to FIG. 1, the present disclosure provides a method for constructing a backtracking analysis model based on an attack chain, including the following Step 1 to Step 6.

Step 1: capturing process creation behaviors, file access behaviors, and network connection behaviors through a security agent deployed in a host kernel layer, and generating event tuples.

In step of generating the event tuples, the security agent is deployed at a Ring-0 privilege level of the host kernel layer, and an isolated execution environment is created through a hardware virtualization technology. The agent hooks key system call functions of an operating system to:
intercept NtCreateProcess to monitor process creation behaviors, capture IRP_MJ_WRITE to track file modification operations, and analyze TdiSend to collect network connection behaviors. The hardware isolation mechanism blocks user-layer malicious tampering to ensure the integrity of original behavior data collection.

Behavior data is transmitted to a differential privacy engine for processing, and an event type sensitivity matrix is loaded to configure noise parameters. For high-frequency operations, a higher privacy budget is adopted to inject Laplacian noise, while for low-frequency sensitive operations, a lower privacy budget is configured to apply micro-disturbances. Atomic operations for feature extraction and noise addition are executed synchronously in a Trusted Execution Environment to eliminate the risk of intermediate-state data exposure in the process of noise injection.

While performing differential processing, attack causal dependency relationships are maintained: an attack execution path is built by tracking process tree fork-exec call chains, data flow directions are recorded by analyzing the cross-process transfer relationships of file handles, and lateral movement links are marked by associating network socket binding states. This causal topology is explicitly encoded as a directed graph data structure, where nodes identify system entities and edges mark attack action types. Finally, orthogonalized noise feature vectors, hashed behavior fingerprints, and serialized directed graph are integrated to generate structured event tuples with attack semantics.

Step 2: inputting the event tuples into a tensor network processing pipeline, through three-dimensional tensor space mapping, encoding behavior fingerprints as 0th-order vectors, orthogonalizing noise feature vectors for filling to a 1st order, converting causal dependency chains into adjacency tensors for storage in a 2nd order, performing tensor chain dimensionality reduction compression driven by a matrix product state model, retaining low-rank hidden variable subspaces with singular values exceeding a preset threshold, synchronously calculating clock offsets of slave nodes with a phase of a master node as a reference via virtual quantum clocks, applying phase rotation operations to generate a clock-generated synchronized event sequence, and integrating them into a time dimension of a low-rank tensor block to form an attack behavior tensor block retaining a spatio-temporal topology.

In the tensor processing process, an input stream of structured event tuples is received by the tensor network processing pipeline. The behavior fingerprints are converted into the discrete 0th-order vectors through one-hot encoding to clearly identify the attack behavior type; the noise feature vectors are processed by Gram-Schmidt orthogonalization to generate orthogonal basis vectors for filling the 1st order to eliminate multicollinearity between features; and the causal dependency chains are converted into asymmetric adjacency tensors with direction weights for storage in the 2nd order, edge weights of which are associated with attack stage transition probabilities. This processing realizes the three-order feature decoupling of behavior type, noise attribute, and causal relationship, thereby avoiding information coupling distortion caused by mixed encoding in existing methods.

When constructing a three-dimensional core tensor structure, the three orders of dimensions separately carry feature semantics: the 0th order maps an attack behavior category space, the 1st order represents a noise disturbance distribution pattern, and the 2nd order encodes attack path causal weights. The matrix product state model decomposes high-dimensional tensors by using an alternating least squares algorithm, truncates low-contribution components with singular values lower than the preset threshold through iterative optimization, and retains the backbone topological features of the attack chain. The generated hidden variable subspaces have the spatio-temporal invariant attributes, and their spatial dimensions maintain the attack propagation relationships between host nodes.

A time correction module is started synchronously, and the virtual quantum clocks use the phase of a hardware clock of the master node as the reference to resolve the relative phase offset angles of the slave nodes through a quantum phase estimation algorithm. Phase rotation operations of complex exponential function transformation are applied to calibrate time pulse sequences, thereby generating a synchronized event sequence with nanosecond-level precision. The timestamp attributes of this sequence are mapped to time-axis coordinate values and integrated into the time dimension channel of the hidden variable subspaces, finally forming a low-rank attack behavior tensor block with spatio-temporal topology coupling.

Step 3: inputting the attack behavior tensor block through a reinforcement learning controller, modeling a current attack chain as a directed acyclic graph with security events as nodes and attack stage transition probabilities as edges, and outputting an event importance score vector marking privileged credential access nodes.

In the attack chain modeling and evaluation process, the reinforcement learning controller loads the data stream of the attack behavior tensor block. Based on the time dimension attributes of the tensor block, the temporal partial order relationship of attack events is parsed, and security event instances are mapped to node objects of the directed acyclic graph. Node attributes include event type, timestamp, and host identifier; directed connection edges between nodes are constructed according to spatial dimension data, and edge weights are calculated as the MITRE ATT&CK tactics transition probabilities of adjacent event attack actions. This graph structure explicitly encodes the attack stage transition path.

A connectivity loss calculation module simulates event discarding operations, and identifies key attack path nodes through a topological sorting algorithm. Node retention rate is calculated as the proportion of key path nodes that are not discarded, and edge association strength is quantified based on the semantic similarity of attack actions. A connectivity loss value is calculated by using a composite quantization model, and the value is 1 minus a product of the node retention rate and the edge association strength. The greater the value, the greater the degree of damage to the integrity of the attack chain.

An event importance scoring engine implements a three-level scoring rule: privileged credential access nodes are given the highest risk weight, sensitive data operation type nodes are assigned a medium weight, and routine operation events are marked with a basic score. An output score vector encapsulates key-value pairs of node indices and risk levels, and values of the risk levels are mapped to a preset score interval. This vector serves as the basis for priority allocation in downstream construction of the risk-marked sampled event set.

Step 4: receiving a risk-marked sampled event set through a dynamic routing engine, constructing a gradient boosting decision tree model to analyze event burst frequency and correlation entropy, assigning events to a genetic path optimization channel when the burst frequency exceeds a first threshold, assigning events to a Bayesian inference channel when the correlation entropy is lower than a second threshold, and assigning events to an ant colony completion channel when the events satisfy neither that the burst frequency exceeds the first threshold nor that the correlation entropy is lower than the second threshold.

In the dynamic routing process of the event set, the dynamic routing engine receives an input stream of the risk-marked sampled event set. When constructing the gradient boosting decision tree model, the event burst frequency is calculated using a sliding window counting method to count a peak value of event volume per unit time, the correlation entropy is calculated based on the Shannon entropy formula to calculate the causal dependency strength between events, and the risk marker features are mapped to preset weight level values. The decision tree uses the Gini coefficient as the splitting criterion to generate multi-branch decision rules.

The allocation of events implements a three-level shunting strategy: when the burst frequency exceeds the first threshold, events are determined as a high-throughput attack behavior flow and assigned to the genetic path optimization channel for fast evolutionary calculation; when the correlation entropy is lower than the second threshold, events are identified as a low-complexity associated event set and routed to the Bayesian inference channel for probabilistic inference; for remaining events, priorities are allocated based on risk level weights, where high-privilege risk events are given a larger weight factor, medium-low risk events are deweighted proportionally, and input to the ant colony completion channel through a weighted round-robin scheduling algorithm.

The three types of event sets output to the parallel inference space are subjected to format conversion: genetic channel event sequence is encoded as a chromosome gene bit string, Bayesian channel data is encapsulated as a probabilistic event object with a confidence interval, and ant colony channel events are converted into pheromone diffusion nodes. The converted data format adapts to the input specifications of each channel processing engine and maintains the risk marker inheritance relationship.

Step 5: performing the following on attack chain fragments output by a parallel inference space through a multi-simulation verification system: physically replaying in a container cluster to generate a process behavior heat report, calculating instruction flow offsets and memory dirty data ratios based on system call baseline templates and outputting digital anomaly vectors, deploying a generative adversarial network to inject camouflaged attack events and generating an adversarial robustness score; and fusing the heat report, anomaly vectors, and robustness score through a meta-verifier to generate a comprehensive anti-interference index.

In the attack chain verification process, the multi-simulation verification system loads an attack chain graph output by the parallel inference space. A container cluster environment accurately reproduces an attack sequence: mirrored host nodes are started to execute the attack instruction flow, and kernel probes hook system call interfaces to track the process creation chain and file operation trajectory, recording timestamped process behavior data to generate the heat report. This report marks the distribution areas and propagation paths of high-risk operations in container nodes.

An instruction flow analysis engine captures the machine instruction sequence of a replay environment, and loads the pre-constructed system call baseline templates for comparing with actual instruction flows. The Hamming distance offsets between the two are calculated to quantify processor behavior anomaly degree, and the dirty data ratios marked by the memory page modification states are counted to detect unauthorized tampering. The digital behavior anomaly vectors are generated by fusing the anomaly degree and tampering index, and the vector dimensions correspond to central processing unit behavior offset intensity and memory integrity damage degree, respectively.

The generative adversarial network is deployed to construct temporally correlated camouflaged attack events to: insert interference signals such as simulated registry access and file read-write operations within a same execution cycle. A discriminant network analyzes the context semantic consistency of the events, and calculates the adversarial robustness score based on an abnormal semantic matching proportion. This score characterizes the ability of a defense system to identify camouflaged attacks in the form of a percentage.

The meta-verifier receives three-way inputs: the heat report, the anomaly vectors, and the robustness score, and implements hierarchical evidence fusion: the heat report locates physical-layer high-risk operation areas, the anomaly vectors mark digital-layer deviated subsystem, and the robustness score quantifies defense-layer vulnerability. The comprehensive anti-interference index is generated by integrating three-dimensional indicators through a weighted decision function, and the index includes a composite data structure of spatial coordinates and intensity ratings.

Step 6: detecting a deviation between a physical replay and a digital model in the comprehensive anti-interference index, generating a weight adjustment coefficient γ when the deviation exceeds a preset tolerance, feeding back γ to the reinforcement learning controller in a closed loop to dynamically update loss function parameters, and feeding back γ to the dynamic routing engine to adjust a channel weight allocation strategy.

In the dynamic correction parameter generation process, the meta-verifier parses a three-dimensional dataset of the comprehensive anti-interference index. Process heat trajectories recorded in the physical replay environment are extracted as an actual behavior streamline, and matched with predicted trajectories output by a digital twin model via a dynamic time warping algorithm. The spatio-temporal offset between the trajectories is calculated as a deviation index, which integrates path point displacement difference and time window misalignment.

When the spatio-temporal offset is detected to exceed a preset tolerance threshold, a parameter correction engine starts a weight adjustment mechanism. A dynamic tuning factor γ is generated, and its value is constructed in accordance with a negative correlation function principle: when the deviation increases, the value of γ decreases progressively to reflect the attenuation of system confidence. The factor γ, as a core correction parameter, is encapsulated as a control signal object.

A closed-loop feedback system performs dual-channel synchronous adjustment: a first channel feeds back to the reinforcement learning controller to update the sampling decision weight α and path integrity weight β in a connectivity loss function through a gradient backpropagation algorithm; and a second channel feeds back to the dynamic routing engine to adjust the processor resource quota of the genetic optimization channel, Bayesian inference channel, and ant colony completion channel in proportion according to the value of γ. This two-way adjustment mechanism enables an attack chain analysis system to continuously adapt to the state fluctuations of a security event stream.

In the method for constructing a backtracking analysis model based on an attack chain, the security agent is first deployed in the host kernel layer to monitor system call behaviors, including process creation, file access, and network connection operations, through a hardware isolation environment. The differential privacy engine of the security agent injects noise into original behavior features according to the event type sensitivity matrix, while retaining process parent-child relationship chains and file handle inheritance relationships, constructs a topology chain explicitly encoding attack causal dependencies, and integrates them to output the structured event tuples including behavior fingerprints, noise-processed feature vectors, and causal dependency chains.

After receiving the event tuples, the tensor network processing pipeline performs three-dimensional space mapping operations to: encode the behavior fingerprints as the 0th-order vectors of the tensor, process the noise feature vectors by Gram-Schmidt orthogonalization for filling to the 1st order, and convert causal dependency chains into asymmetric adjacency tensors for storage in a 2nd order. After constructing the three-dimensional core tensor structure, the matrix product state model performs tensor chain dimensionality reduction compression on core tensor to retain the hidden variable subspaces with singular values exceeding the preset threshold. The time correction module is started synchronously, the clock offsets of the slave nodes are calculated through the quantum phase estimation algorithm, the virtual quantum clocks are called to apply the phase rotation operations to generate the synchronized event sequence, and its time dimension attributes are integrated into the time-axis coordinate of the hidden variable subspaces, finally forming the attack behavior tensor block retaining the spatio-temporal topology.

The reinforcement learning controller inputs the attack behavior tensor block and models the current attack chain as the directed acyclic graph based on the time dimension attributes: the nodes in the graph are security events, and the edges are attack stage transition probabilities. The connectivity loss value of event discarding to the attack chain topology integrity is calculated, and the value is quantified by the formula: 1 minus the product of the key path node retention rate and the edge association strength, where the node retention rate is extracted from the spatial dimension data of the tensor block. The event importance score vector is output to mark high-risk levels for the privileged credential access nodes, forming the basis for the risk-marked sampled event set.

After receiving the updated sampled event set, the dynamic routing engine constructs the gradient boosting decision tree model to analyze the event burst frequency, correlation entropy, and risk marker features. The decision rule is: events with the burst frequency exceeding the first threshold are assigned to the genetic path optimization channel; events with the correlation entropy lower than the second threshold are assigned to the Bayesian inference channel; and events that satisfy neither the frequency threshold nor the entropy threshold are weighted according to risk marking levels and assigned to the ant colony completion channel. The classified event sets are output to the corresponding channels of the parallel inference space.

The parallel inference space inputs the three types of event sets into the Bayesian inference channel, genetic optimization channel, and ant colony completion channel respectively for processing, generates path hypothesis fragments for storing in a shared memory pool. When inter-channel path consistency is lower than ninety percent, the generative adversarial network is activated to complete the topological breakpoints in the path hypothesis fragments, and the completed fragments are applied to generate an attack chain graph marked with the optimization trajectories of each channel.

The multi-simulation verification system receives the attack chain graph, physically replays the attack sequence in the container cluster, and records process behavior trajectories via the kernel probes to generate the heat report. The instruction flow Hamming distance offsets and memory page dirty data ratios are calculated based on the system call baseline templates to output digital behavior anomaly index vectors. The generative adversarial network is deployed to inject the temporally correlated camouflaged events, and the adversarial robustness score is generated based on the misjudgment probability of the discriminant network for context semantics. The meta-verifier fuses the heat report, anomaly vectors, and robustness score to generate the comprehensive anti-interference index, which is output to a deviation correction module to detect the deviation between the physical replay and a digital model trajectory. When the deviation exceeds the preset tolerance, the weight adjustment coefficient γ is generated as the dynamic tuning factor, which is fed back to the reinforcement learning controller in a closed loop to update connectivity loss function parameters and simultaneously fed back to the dynamic routing engine to adjust the channel weight allocation strategy, forming an adaptive optimization closed loop for attack chain analysis.

Specifically, in the method for constructing a backtracking analysis model based on an attack chain of the present disclosure, said generating event tuples includes:
through the security agent, intercepting system call behaviors in a hardware-isolated environment, and extracting original features of the process creation behaviors, file access behaviors, and network connection behaviors;
in a differential privacy engine of the security agent, injecting differential noise into the original features according to a preset event type sensitivity matrix, and performing atomic operations for feature extraction and noise injection;
simultaneously retaining process parent-child relationship chains and file handle inheritance relationships in a process of noise injection to construct topology chains explicitly encoding attack causal dependencies; and
integrating noise-processed feature vectors, behavior fingerprints, and topology chains to generate structured event tuples including causal dependency chains.

During the generation of the event tuples, the security agent is deployed in the hardware-isolated environment of a host Ring-0 layer, and intercepts behavior data by hooking key system calls, specifically including hooking NtCreateProcess to monitor process creation behaviors, capturing IRP_MJ_WRITE to track file modification operations, and analyzing TdiSend to collect network connection behaviors. The differential privacy engine configures noise parameters according to the event type sensitivity matrix, generates Laplacian noise with a higher privacy budget for high-frequency operations, injects micro-disturbances with a lower privacy budget for low-frequency sensitive operations, and performs feature extraction and noise addition synchronously in the trusted execution environment in an atomic operation manner to avoid intermediate-state data exposure.

The original behavior dependencies are maintained during noise injection: the attack execution path is constructed based on the process tree parent-child chains, the data flow directions are recorded by tracking the cross-process transfer relationships of file handles, and the lateral movement links are marked by associating the network socket binding states. A causal dependency topology chain is explicitly encoded as a directed graph structure, where nodes represent system entities and edges mark attack action types. Finally, the orthogonalized noise feature vectors, behavior fingerprint hash values, and directed graph structure serialization are serialized and integrated to generate the structured event tuples including attack semantics and privacy protection features.

Specifically, in the method for constructing a backtracking analysis model based on an attack chain of the present disclosure, generating the low-rank tensor block includes:
receiving an input data stream from the event tuples in the tensor network processing pipeline;
performing tensor space mapping operations to: encode the behavior fingerprints in the event tuples as 0th-order vectors of a tensor, process the noise feature vectors in the event tuples by Gram-Schmidt orthogonalization for filling to the 1st order, and convert the causal dependency chains in the event tuples into asymmetric adjacency tensors for storage in the 2nd order;
constructing a three-dimensional core tensor structure, where three orders of the three-dimensional core tensor structure respectively carry behavior type features, noise distribution attributes, and attack causal weights; and

decomposing the three-dimensional core tensor structure through a matrix product state model in the tensor network processing pipeline, and retaining the hidden variable subspaces with the singular values exceeding the preset threshold to generate the low-rank tensor block carrying spatio-temporal invariants.

During the generation of the low-rank tensor block, the tensor network processing pipeline receives the structured event tuple data stream. The behavior fingerprints are converted into the discrete 0th-order vectors through one-hot encoding to clearly identify the attack behavior type; the noise feature vectors are processed by Gram-Schmidt orthogonalization to eliminate multicollinearity, forming orthogonal basis vectors for filling to the 1st order; and the causal dependency chains are converted into asymmetric adjacency tensors with direction weights for storage in the 2nd order, edge weights of which are associated with attack stage transition probabilities. This processing separates three types of heterogeneous features of behavior type, noise attribute, and causal relationship, thereby avoiding information loss caused by mixed encoding in existing methods.

When constructing the three-dimensional core tensor, the three orders strictly carry features separately: the 0th order maps an attack behavior type space, the 1st order represents the noise disturbance distribution pattern, and the 2nd order encodes the attack path causal weights. The matrix product state model decomposes the high-dimensional tensor by using the alternating least squares algorithm, truncates low-contribution components with singular values smaller than the preset threshold through iterative optimization, and retains the backbone topological structure of the attack chain. The generated hidden variable subspaces carry the spatio-temporal invariant attributes, their time dimensions are calibrated through the synchronized event sequence, and their spatial dimensions maintain the attack propagation relationships between host nodes, forming a low-rank representation resistant to compression distortion.

Specifically, in the method for constructing a backtracking analysis model based on an attack chain of the present disclosure, the Step 2 includes:
receiving to-be-corrected event timestamp sequences in the event tuples through a time correction module;
calculating the offsets of clocks of the slave nodes relative to the master node with a clock of the master node as a phase reference through a quantum phase estimation algorithm;
invoking the virtual quantum clocks to apply the phase rotation operations to the clocks of the slave nodes, and generating the synchronized event sequence eliminating clock drift;
inputting the synchronized event sequence into a low-rank tensor block construction process, and integrating time dimension attributes of the synchronized event sequence into time-axis coordinates of the hidden variable subspaces.

During the timestamp offset correction, the time correction module receives event timestamp sequences from distributed nodes. Taking the phase of the hardware clock of the master node as the reference, the offsets of the clocks of the slave nodes are resolved through the quantum phase estimation algorithm: this method maps the timestamp sequences of the respective nodes to imaginary exponential components, calculates the arctangent values by summing the imaginary and real parts, and obtains the relative phase offset angles. The virtual quantum clocks apply the phase rotation operations according to the offset angles, calibrates the time pulse sequences through complex exponential function transformation, generates the synchronized event sequence with nanosecond-level precision, and eliminates the microsecond-level time deviation caused by clock drift.

The time information after synchronous processing is integrated into the low-rank tensor block construction process through a time-axis coordinate system. This time-axis coordinate system correlates with the hidden variable subspaces of the three-dimensional core tensor, encoding the calibrated event timestamp sequences into time dimension attribute values and explicitly marking the partial order relationships of attack events in the tensor space. This process preserves the causal timing logic of attack stage transitions while providing a unified temporal reference for subsequent spatio-temporal topology analysis.

Specifically, in the method for constructing a backtracking analysis model based on an attack chain of the present disclosure, the Step 3 includes:
inputting the low-rank tensor block into the reinforcement learning controller;
in the reinforcement learning controller, modeling the current attack chain as the directed acyclic graph with the security events as the nodes and the attack stage transition probabilities as the edges based on time dimension attributes of the low-rank tensor block;
calculating a connectivity loss value of event discarding operations to attack chain topology integrity, where the connectivity loss value L is quantified by a formula: L=1−(key path node retention rate×edge association strength), and the key path node retention rate is extracted from spatial dimension data of the low-rank tensor block; and
outputting the event importance score vector that generates high-risk markers for the privileged credential access nodes as a basis for constructing the risk-marked sampled event set.

In the process of attack chain connectivity loss calculation, the reinforcement learning controller receives the low-rank tensor block as input and resolves the temporal partial order relationships of attack events based on the time dimension attributes. The current attack chain is modeled as a directed acyclic graph structure: nodes correspond to security event instances, and edges represent attack stage transition probability weights. The key path nodes are identified through the topological sorting algorithm applied to spatial dimension data, and the retention rate is calculated as the proportion of the key path nodes remaining after a sampling operation; edge association strength is quantified based on the semantic similarity of attack actions between adjacent nodes.

The connectivity loss value is calculated using the composite quantization model, and its numerical value is characterized by the product of the retention rate of the key path nodes and the edge association strength, representing the overall topological integrity. The final loss value is expressed as 1 minus this integrity. The event discarding operations simulate the destructive impact of the sampling compression process on the attack chain. The output event importance score vector implements a three-level marking rule to: generate high-level risk markers for privileged credential access nodes, mark medium risk for sensitive data operation type nodes, and label basic risk for routine operation events. This score vector, combined with the original event set, forms a basic data layer of the risk-marked sampled event set.

Specifically, in the method for constructing a backtracking analysis model based on an attack chain of the present disclosure, the Step 4 includes:
continuously monitoring tactical phase transition states of the security events in the reinforcement learning controller, and identifying stage jump events by comparing MITRE ATT&CK tactical labels in the attack behavior tensor block;
activating a feature reconstruction module to load corresponding time period events from an originally captured data stream of the host kernel layer when a stage jump is detected and privileged node-related events marked by the event importance score vector are missing;
processing the loaded events through a feature reconstruction algorithm to generate a reconstructed subset including markers for high-risk privileged nodes; and
merging the reconstructed subset with a current sampled event set to generate an updated sampled event set with dynamic risk markers for outputting to the dynamic routing engine.

During the generation of the risk-marked sampled event set, the reinforcement learning controller continuously scans the tactical phase labels of the attack behavior tensor block, comparing against the tactical transition patterns in the MITRE ATT&CK framework to detect stage transition events. When a tactical switch from lateral movement to credential access is identified, the presence of privileged node-related events is verified by combining with the event importance score vector. If a stage transition is detected and privileged node events are missing, the feature reconstruction module is activated to retrieve the original behavior capture stream from the host kernel layer through a secure channel, loading the non-downsampled events within the corresponding time window.

The feature reconstruction algorithm performs denoising and feature alignment operations on the loaded events: high-frequency noise perturbations are filtered through orthogonal projection, missing event nodes are complemented using a causal dependency graph, and a sub-dataset including a complete privileged operation sequence is reconstructed. This reconstructed subset inherits the risk marking rule of the original events, adding high-level risk markers to privileged credential access events. Finally, the reconstructed subset is merged with the current sampled event set in an ordered manner based on timestamps, generating the updated event set with dynamic risk markers for outputting to the dynamic routing engine.

Specifically, in the method for constructing a backtracking analysis model based on an attack chain of the present disclosure, the Step 4 further includes:
receiving the updated sampled event set with dynamic risk markers through the dynamic routing engine;
constructing the gradient boosting decision tree model in the dynamic routing engine, taking risk marker features, event burst frequency, and correlation entropy in the updated sampled event set as input features;
calculating event allocation weights through the decision tree model to: assign events to the genetic path optimization channel when the event burst frequency exceeds a first preset threshold, assign events to the Bayesian inference channel when the event correlation entropy is lower than a second preset threshold, and weight events according to risk marking levels and assign the events to the ant colony completion channel when the events satisfy neither that the burst frequency exceeds the first threshold nor that the correlation entropy is lower than the second threshold; and
outputting classified three types of event sets to corresponding channels of the parallel inference space.

During the allocation of the sampled event set, the dynamic routing engine receives the input stream of the updated event set with dynamic risk markers. When constructing the gradient boosting decision tree model, the input feature dimensions include: the risk marker features are mapped as discrete level values, the event burst frequency is calculated by the sliding window counting method to obtain the peak count of events per unit time, and the correlation entropy is quantified based on the Shannon entropy formula to measure the causal dependency strength between events. This decision tree model uses the Gini coefficient as the splitting criterion to generate classification rules.

The event allocation rule implements the three-level shunting strategy: events with the burst frequency exceeding the first threshold are determined as high-throughput attack behaviors and routed to the genetic path optimization channel for fast path evolution; events with the correlation entropy lower than the second threshold are identified as low-complexity associated events and assigned to the Bayesian inference channel for probabilistic inference; remaining events are reallocated priorities based on risk level weight factors, where high-privilege risk events obtain larger weights, medium-low risk events are deweighted proportionally, and the weighted event stream is input to the ant colony completion channel through a round-robin scheduling algorithm. The three types of event sets output to the parallel inference space maintain the risk marker inheritance relationship.

Specifically, in the method for constructing a backtracking analysis model based on an attack chain of the present disclosure, the Step 5 includes:
receiving the classified three types of event sets output by the dynamic routing engine;
inputting the three types of event sets into the Bayesian inference channel, genetic path optimization channel, and ant colony completion channel for processing, respectively, generating path hypothesis fragments, and storing them in a shared memory pool;
activating the generative adversarial network to complete topological breakpoints in the path hypothesis fragments when inter-channel path consistency is lower than 90%; and
applying the completed path hypothesis fragments to generate an attack chain graph marked with optimization trajectories of each channel for outputting to the multi-simulation verification system.

During the operation of the parallel inference space, three types of event sets classified by the dynamic routing engine are received. The Bayesian inference channel loads input events with confidence intervals, applying a Gibbs sampler to infer the probability distribution of potential attack paths; the genetic path optimization channel performs chromosome encoding of event sequences, evolving optimal attack path hypotheses through crossover and mutation operations; the ant colony completion channel constructs a pheromone diffusion model and calculates transition probabilities between nodes by weighting with threat intelligence credibility. Path hypothesis fragments generated by the respective channels are formatted into standard graph structures and then real-time written to the shared memory pool to construct a global path knowledge base.

The shared memory pool implements a 100-millisecond consistency detection cycle, using the Jaccard similarity algorithm to compare the node overlap degree of path fragments from the three channels. When a global path consistency coefficient is lower than ninety percent, it is determined that topological breakpoints exist, activating the generative adversarial network to learn contextual features of missing nodes. This network reconstructs transition nodes conforming to MITRE ATT&CK semantics through conditional generative adversarial mechanisms, completing path breakpoints to form a complete attack transition chain. Finally, an ensemble learning strategy is applied to fuse the completed path fragments, generating an attack chain graph annotated with contribution weights from the respective channels for output to the verification system.

Specifically, in the method for constructing a backtracking analysis model based on an attack chain of the present disclosure, the Step 5 further includes:
receiving the attack chain graph through the multi-simulation verification system;
replaying an attack sequence in the attack chain graph in a container cluster, and generating the heat report by recording process behavior trajectories via kernel probes;
collecting instruction flow sequences during replay based on the system call baseline templates, calculating instruction flow Hamming distance offsets and memory page dirty data ratios, and outputting digital behavior anomaly index vectors;
deploying the generative adversarial network to inject temporally correlated camouflaged events into a replay system, and generating the adversarial robustness score based on misjudgment probability of a discriminant network for context semantics; and
fusing the heat report, anomaly index vectors, and robustness score through the meta-verifier to generate the comprehensive anti-interference index for outputting to a deviation correction module.

During the attack chain verification process, the multi-simulation verification system receives the attack chain graph as input and accurately reproduces the attack sequence in the container cluster environment. The kernel probes are mounted to a kernel of a container operating system to track the process creation chain and file operation trajectory, generating a timestamped process behavior heat report. The sampling frequency of this system call sequence reaches the microsecond level, completely recording the propagation path of attack actions in the simulation environment.

An instruction flow analysis module loads the system call baseline templates and collects the machine instruction sequence during replay. The Hamming distance offsets between the actual instruction flows and the baselines are calculated to quantify the processor behavior anomaly degree; the dirty data ratios marked by the memory page modification states are statistically calculated to capture unauthorized memory tampering operations. The digital behavior anomaly vectors are generated by fusing the anomaly degree and memory tampering index, reflecting the underlying security status of the system.

The generative adversarial network constructs temporally correlated camouflaged attack events: implanting interference signals in the same time window as the actual attack chain, with injection points covering key operation interfaces such as file read-write and registry access. The discriminant network analyzes the context semantic consistency of the events and calculates the adversarial robustness score based on the abnormal semantic matching proportion. This score measures the system's tolerance to camouflaged attacks.

The meta-verifier receives three-way inputs: the heat report, anomaly vectors, and robustness score, and implements evidence fusion analysis: a heat map locates high-risk operation areas, the anomaly vectors mark subsystems deviating from the baseline, and the anti-interference score quantifies defense vulnerabilities. Three-dimensional evidence is integrated through the weighted decision function, and the comprehensive anti-interference index is output to the deviation correction module to complete the closed-loop verification.

Specifically, in the method for constructing a backtracking analysis model based on an attack chain of the present disclosure, the Step 6 includes:
fusing the process behavior heat report, digital behavior anomaly index vectors, and adversarial robustness score through the meta-verifier to generate the comprehensive anti-interference index;

detecting deviations between physical replay heat trajectories and digital model prediction trajectories based on three-dimensional verification data in the comprehensive anti-interference index;

generating the weight adjustment coefficient γ as a dynamic tuning factor when the deviations exceeds a preset tolerance threshold; and

feeding back γ to the reinforcement learning controller in a closed loop to update connectivity loss function parameters, and simultaneously feeding back γ to the dynamic routing engine to adjust the channel weight allocation strategy.

During the dynamic correction parameter generation process, the meta-verifier fuses the process behavior heat report, digital behavior anomaly index vectors, and adversarial robustness score, and generates the comprehensive anti-interference index through a weighted evidence decision function. The three-dimensional dataset of this index includes physical trajectory heat distribution, system-level anomaly indicators, and defense vulnerability scores, constituting a multi-dimensional benchmark for attack chain verification. Trajectory deviation detection is performed based on this index: the process behavior heat map recorded in the physical replay environment is extracted as the actual trajectory, dynamically time-warped and matched with the predicted trajectories output by the digital twin model, and the spatio-temporal offset of the key attack stage transition path is calculated as the deviation.

When the spatio-temporal offset is detected to exceed the preset tolerance threshold, the parameter correction engine is activated to generate the weight adjustment coefficient γ. As a dynamic tuning factor, the value of this coefficient has a negative correlation functional relationship with the deviation, i.e., the larger the deviation, the smaller the value of γ, indicating the attenuation of system confidence. The coefficient γ is fed back to the reinforcement learning controller in a closed loop, updating the weight parameters α and β of the connectivity loss function through the gradient backpropagation algorithm to optimize the sampling decision accuracy for subsequent attack chain modeling; simultaneously, the coefficient γ is fed back to the dynamic routing engine to proportionally adjust the resource allocation weights of the genetic path channel, Bayesian inference channel, and ant colony completion channel based on the value of γ, forming a two-way adaptive optimization mechanism.

In the method for constructing a backtracking analysis model based on an attack chain, the tensor network processing pipeline implements a three-dimensional feature decoupling algorithm. The behavior fingerprints are converted into discrete vectors through a one-hot encoding algorithm to clearly identify the spatial distribution of attack behavior types. The noise feature vectors are processed using a Gram-Schmidt orthogonalization algorithm to eliminate multicollinearity, generating orthogonal basis vectors to characterize noise disturbance patterns. A graph transformation algorithm is used for the causal dependency chains to construct asymmetric adjacency tensors, whose edge weights are associated with attack stage transition probabilities. The matrix product state model executes a tensor chain dimensionality reduction algorithm, truncating low-singular value components through alternating least squares iterative optimization to retain hidden variable subspaces of the attack chain's backbone topology.

The reinforcement learning controller implements a directed acyclic graph modeling algorithm. Based on time dimension attributes, the temporal sequence relationships of attack events are parsed and a graph theory algorithm is used to construct a topological structure where nodes represent security events and edges mark tactical transition probabilities. For the calculation of connectivity loss, the topological sorting algorithm is used to identify key path nodes, a semantic similarity algorithm is used to quantify edge association strength. The event importance scoring engine uses a hierarchical marking algorithm to assign the highest risk weight to privileged credential access nodes, medium weight to sensitive data operation type nodes, and basic scores to routine events.

The dynamic routing engine executes a gradient boosting decision tree classification algorithm. The input features include risk marking levels, event burst frequency calculated by sliding window statistics, and correlation entropy computed by the Shannon entropy formula. The decision tree model uses the Gini coefficient as the splitting criterion to generate multi-branch rules: high-frequency events are allocated to the genetic path optimization channel to execute a chromosome encoding evolution algorithm, low-entropy events are routed to the Bayesian inference channel to implement a Gibbs sampling inference algorithm, and remaining events are scheduled to the ant colony completion channel based on risk weights to run a pheromone diffusion algorithm.

The parallel inference space implements a multi-modal path reconstruction algorithm. The Bayesian inference channel uses a probabilistic graph model to infer potential attack paths; the genetic optimization channel executes a crossover and mutation evolution algorithm to search for optimal path hypotheses; and the ant colony completion channel adopts a positive feedback mechanism to calculate transition probabilities between nodes. When insufficient path consistency is detected, the generative adversarial network uses a conditional generation algorithm to complete topological breakpoints and reconstruct transition nodes conforming to ATT&CK framework semantics.

The multi-simulation verification system runs a physical-digital comparison algorithm. When the container cluster replays the attack sequence, the kernel probes implement a behavior trajectory tracking algorithm to generate the heat report. The instruction flow analysis module uses a Hamming distance algorithm to calculate processor behavior offsets, and outputs digital anomaly vectors in combination with a memory page dirty data statistics algorithm. The generative adversarial network executes a context semantic discrimination algorithm to generate the robustness score based on a misjudgment rate of camouflaged events.

The meta-verifier implements an evidence fusion decision algorithm. It weightily integrates the heat report, spatial high-risk area localizations, system-layer deviation markers of anomaly vectors, and defense vulnerability quantification of robustness score, and generates the comprehensive anti-interference index. The deviation detection module uses the dynamic time warping algorithm to match physical trajectories with digital models, and generates weight adjustment coefficient constructed by the negative correlation function when offsets exceed a limit. The closed-loop feedback mechanism executes a dual-path regulation algorithm: the gradient backpropagation algorithm updates a reinforcement learning loss function, and a resource quota allocation algorithm optimizes dynamic routing channel weights.

In the method for constructing a backtracking analysis model based on an attack chain, the security agent model is deployed in the hardware-isolated environment of the host kernel layer. This model hooks key system call interfaces of the operating system to intercept process creation behaviors, file modification operations, and network connection activities, collecting the original behavior feature data stream. The differential privacy model loads the event type sensitivity matrix to configure noise parameters, applies Laplacian noise perturbations to high-frequency operations, injects micro-noise into low-frequency sensitive operations, and synchronously complete feature extraction and noise addition operations in the trusted execution environment.

The tensor network processing model receives the structured event tuples as input. The behavior fingerprint encoding model implements one-hot encoding conversion to generate discrete 0th-order vectors; the noise feature orthogonalization model uses the Gram-Schmidt algorithm to generate the orthogonal basis vectors to fill the 1st-order; the causal dependency conversion model constructs the asymmetric adjacency tensors for storage in the 2nd-order. The matrix product state model decomposes the three-dimensional core tensor, truncates low-contribution singular value components through alternating least squares iterative optimization, and retains the backbone topological features of the attack chain.

The reinforcement learning control model constructs the directed acyclic graph structure based on the time dimension attributes. Nodes are mapped to security event instances, and edge weights are calculated as MITRE ATT&CK tactical transition probabilities. The connectivity loss model implements the topological sorting algorithm to identify the key path nodes, and quantifies the edge association strength in combination with the semantic similarity. An event scoring model executes the three-level marking rule: assigning high-level risk values to privileged credential access nodes, allocating medium risk values to sensitive data operation type nodes, and marking basic scores for routine events.

The dynamic routing decision model constructs the gradient boosting tree classification structure. Input features include risk marking levels, event burst frequency calculated by sliding window statistics, and correlation entropy computed by the Shannon entropy. The allocation rule model implements three-level shunting: high-frequency events are routed to the genetic optimization channel to execute chromosome encoding evolution, low-entropy events are allocated to the Bayesian channel to perform probabilistic inference, and remaining events are scheduled to the ant colony channel for completion based on risk weights.

The parallel inference space model operates a multimodal processing mechanism. The Bayesian inference model employs a Gibbs sampler to infer the probability distribution of potential attack paths. The genetic optimization model performs crossover and mutation operations to evolve optimal path hypotheses. The ant colony completion model constructs a pheromone diffusion network to calculate node transition probabilities. The generative adversarial network is activated when path consistency is insufficient, to reconstruct transition nodes conforming to MITRE ATT&CK semantics to complete topological breakpoints.

The multi-simulation verification model replays the attack chain in the container environment. The behavior trajectory tracking model records process activities via kernel probes to generate the heat report. The instruction flow analysis model calculates Hamming distance offsets to quantify processor anomalies. The memory tampering detection model counts the proportion of dirty pages to mark unauthorized modifications. The adversarial testing model injects time-window-synchronized camouflaged events, and generates a robustness score based on semantic discrimination errors.

The meta-verifier model implements evidence fusion decision. It weightedly integrates the spatial distribution features of the heat report, the system-level deviation indicators of the anomaly vectors, and the defense vulnerability parameters of the robustness score to generate the comprehensive anti-interference index. The deviation correction model detects the spatio-temporal offset between the physical trajectory and the digital prediction, and generates the weight adjustment coefficient constructed by the negative correlation function when the offset exceeds the tolerance. The dual-channel feedback model performs closed-loop regulation: the gradient propagation algorithm updates the reinforcement learning loss parameters, and the resource quota model dynamically allocates multi-channel processing weights.

The security agent deployment algorithm creates the hardware-isolated environment in the operating system kernel layer, collects original data of process creation, file modification, and network connection behaviors by monitoring system call interfaces.

The differential privacy processing algorithm injects noise perturbations based on event sensitivity levels: Laplacian noise is added to high-frequency operations, micro-disturbances are applied to sensitive operations, and atomic operations for feature extraction and noise mixing are synchronously completed in the trusted execution environment.

The topological chain construction algorithm maintains process tree fork-exec call chains to record attack execution paths, tracks cross-process transfer relationships of file handles to mark data flow directions, and explicitly encodes attack causal dependency relationships.

The three-dimensional tensor mapping algorithm converts behavior type features into discrete vectors through one-hot encoding, generates basis vectors via Gram-Schmidt orthogonalization for noise attributes, and transforms causal dependencies into weighted directed adjacency tensors.

The matrix product state dimensionality reduction algorithm decomposes high-dimensional tensors using alternating least squares iteration, truncates components with singular values lower than the threshold, and retains hidden variable subspaces of the attack chain's backbone topology.

The time synchronization calibration algorithm calculates offsets of the slave nodes through quantum phase difference based on the clock phase reference of the master node, and applies complex exponential transformations to generate the nanosecond-level synchronized event sequence.

The directed acyclic graph modeling algorithm maps nodes to security event instances, calculates edge weights as MITRE ATT&CK tactical transition probabilities, and constructs a model of attack stage transition paths.

The connectivity loss calculation algorithm uses topological sorting to identify key path nodes, quantifies edge association strength in combination with combines with semantic similarity, and evaluates the destructive impact of event discarding to the integrity of the attack chain.

The three-level risk marking strategy assigns the highest risk values to privileged credential access operations, marks medium risk for sensitive data modifications, and retains basic scores for routine system operations.

The gradient boosting decision tree routing algorithm takes input features including risk levels, event burst peak frequencies from sliding window statistics, and correlation complexity computed by Shannon entropy.

The genetic channel allocation strategy: events with burst frequency exceeding the threshold are routed to the chromosome encoding evolution channel, to execute crossover and mutation operations to optimize attack path hypotheses.

The Bayesian channel allocation strategy: events with low-correlation entropy are assigned to the probabilistic inference channel, to use the Gibbs sampler to infer the probability distribution of potential attack paths.

The ant colony completion scheduling strategy: remaining events are allocated to the pheromone diffusion channel based on risk level weights, to calculate transition probabilities between nodes through the positive feedback mechanism.

The adversarial path completion algorithm activates a conditional generative adversarial network to reconstruct transition nodes conforming to ATT&CK semantics when insufficient overlap degree of path nodes between channels is detected.

The physical replay verification algorithm accurately reproduces attack sequences in the container cluster environment, with the kernel probes tracking process behaviors to generate a spatio-temporal distribution heat map.

The instruction flow offset detection algorithm compares binary differences between to-be-executed machine instructions and baseline templates, and calculates Hamming distances to quantify processor behavior anomaly degree.

The adversarial robustness testing algorithm injects time-window-synchronized camouflaged attack events, and generates system defense capability scores through the misjudgment rate of semantic discrimination networks.

The three-dimensional evidence fusion strategy: the spatial distribution features of the heat report, digital anomalies characterized by instruction flow offsets, and defense robustness score are weightedly integrated.

The dynamic feedback adjustment mechanism generates a negative correlation weight coefficient to update loss function parameters and channel resource quotas in a closed-loop manner when the deviation between the physical trajectory and the digital model exceed the limit.

In a specific implementation of the method for constructing a backtracking analysis model based on an attack chain, aiming at the technical problem of delayed discovery of threat behaviors caused by attack chain breakage under the impact of massive security events, efficient backtracking analysis is realized through the following technical solution:

A security agent is deployed at a host kernel layer, and system call behaviors are intercepted through a hardware virtualization isolated environment. NtCreateProcess is hooked to monitor process creation, IRP_MJ_WRITE is captured to track file operations, and TdiSend is analyzed to collect network connection behaviors. A differential privacy engine injects Laplacian noise according to an event type sensitivity matrix, with atomic operations for feature extraction and noise addition executed synchronously in a trusted execution environment. Meanwhile, a process tree fork-exec call chain is maintained to construct attack paths, track file handle transfer relationships to record data flow directions, and form structured event tuples including behavior fingerprints, noise features, and causal topologies.

A tensor network processing pipeline receives the event tuples and then implements third-order feature decoupling: the behavior fingerprints are mapped to 0th-order discrete vectors through one-hot encoding, the noise features are processed by Gram-Schmidt orthogonalization to generate orthogonal basis vectors for filling a 1st order, and causal dependency chains are converted into asymmetric adjacency tensors with direction weights for storage in a 2nd order. A matrix product state model decomposes a three-dimensional core tensor by using an alternating least squares algorithm, truncates low-contribution components with singular values lower than a preset threshold, and retains hidden variable subspaces of the attack chain's backbone topology. Simultaneously, clock offsets of slave nodes are parsed through a quantum phase estimation algorithm, virtual quantum clocks apply complex exponential transformations to calibrate time pulse sequences, synchronized timestamps are integrated into time-axis coordinates of the subspaces to form a spatio-temporally coupled low-rank attack behavior tensor block.

A reinforcement learning controller constructs a directed acyclic graph model based on time dimension attributes of the tensor block, with nodes corresponding to security event instances and edge weights calculated as MITRE ATT&CK tactics transition probabilities. A connectivity loss module simulates event discarding operations, identifies key path nodes through topological sorting, and calculates a loss value by using a composite quantization model. A three-level risk score vector is outputted: a privileged credential access node is marked with a high-risk value, a sensitive operation node is marked with a medium-risk value, and a routine event is marked with a basic value. When a tactical stage jump is detected and a high-risk node is missing, a feature reconstruction module is activated to load an event reconstruction subset from a kernel original data stream.

A dynamic routing engine constructs a gradient boosting decision tree model, with input features including risk marker levels, event burst frequency counted by a sliding window, and correlation entropy calculated by Shannon entropy. Three-level shunting is implemented: high-frequency events are allocated to a genetic channel for chromosome encoding evolution, low-entropy events are routed to a Bayesian channel for Gibbs sampling inference, and remaining events are round-robin scheduled to an ant colony channel for completion according to risk weights. A parallel inference space outputs path hypothesis fragments to a shared memory pool. When inter-channel node overlap degree is lower than a threshold, a conditional generative adversarial network is activated to reconstruct transition nodes conforming to ATT&CK semantics to complete topological breakpoints.

A multi-simulation verification system replays an attack chain graph in a container cluster, with the kernel probes tracking process behaviors to generate a heat report. An instruction flow analysis module calculates Hamming distance offsets between actual instruction flows and baseline templates, counts memory dirty page ratios, and outputs digital anomaly vectors. The generative adversarial network injects time-window-synchronized camouflaged events, and generates a robustness score based on a discriminant network's semantic misjudgment rate. A meta-verifier fuses three-dimensional evidence to generate a comprehensive anti-interference index; when deviations between physical heat trajectories and digital prediction trajectories exceed tolerance limits, a weight adjustment coefficient γ constructed by a negative correlation function is generated. This coefficient is fed back in a closed loop to the reinforcement learning controller to update loss function parameters and adjust dynamic routing channel resource quotas, thereby forming an adaptive optimization closed loop for an attack chain analysis system.

According to the solution of the present invention, data volume is compressed by a factor of 1000 through tensor dimensionality reduction while maintaining key path topology; the dynamic routing mechanism ensures priority processing of high-frequency attack events and privileged operations; the closed-loop feedback system continuously corrects model deviations, effectively solving the technical defect of missing key attack stages caused by event overload in existing solutions.

The present invention constructs the tensor network processing pipeline, mapping high-dimensional security event streams to a three-dimensional tensor space. Through hierarchical encoding of behavior fingerprints, noise features, and causal dependency chains and in combination with matrix product state model compression, spatio-temporal topological structures are retained. This process compresses the original data volume by 1/1000 while maintaining causal invariance of attack paths, breaking through the bottleneck of key node loss caused by existing dimensionality reduction technologies, and ensuring attack chain integrity from the data source.

The dynamic decision mechanism realizes accurate screening of key events. The reinforcement learning controller models the directed acyclic graph based on the attack behavior tensor block, calculates the loss value of event discarding to attack chain connectivity, and generates privileged node risk markers. The risk-driven routing engine implements three-level shunting according to event burst frequency, correlation entropy, and risk levels, achieving that high-frequency attack stage events and privileged credential operations preferentially enter the genetic optimization channel. The feature reconstruction mechanism is activated during the tactical stage jump to dynamically fill key event loss, eliminating path breakages caused by sampling bias.

The closed-loop verification and optimization system establishes dual feedback adjustment. Multi-simulation environment replays attack chains to generate physical trajectory heat maps, digital behavior anomaly index vectors, and adversarial robustness scores; the meta-verifier fuses them to generate the comprehensive anti-interference index. When the deviations between physical trajectories and digital models exceed the tolerance limits, the weight adjustment coefficient γ dynamically updates loss function parameters and synchronously adjusts multi-channel inference resource allocation ratios. This mechanism enables the attack chain analysis model to continuously adapt to changes in event stream states, maintaining timeliness of threat behavior detection.

What is claimed is:

1. A method for constructing a backtracking analysis model based on an attack chain, comprising:
Step 1: capturing process creation behaviors, file access behaviors, and network connection behaviors through a security agent deployed in a host kernel layer, and generating event tuples;
Step 2: inputting the event tuples into a tensor network processing pipeline, through three-dimensional tensor space mapping, encoding behavior fingerprints as 0th-order vectors, orthogonalizing noise feature vectors for filling to a 1st order, converting causal dependency chains into adjacency tensors for storage in a 2nd order, performing tensor chain dimensionality reduction compression driven by a matrix product state model, retaining low-rank hidden variable subspaces with singular values exceeding a preset threshold, synchronously calculating clock offsets of slave nodes with a phase of a master node as a reference via virtual quantum clocks, applying phase rotation operations to generate a clock-generated synchronized event sequence, and integrating them into a time dimension of a low-rank tensor block to form an attack behavior tensor block retaining a spatio-temporal topology;
Step 3: inputting the attack behavior tensor block through a reinforcement learning controller, modeling a current attack chain as a directed acyclic graph with security events as nodes and attack stage transition probabilities as edges, and outputting an event importance score vector marking privileged credential access nodes;
Step 4: receiving a risk-marked sampled event set through a dynamic routing engine, constructing a gradient boosting decision tree model to analyze event burst frequency and correlation entropy, assigning events to a genetic path optimization channel when the burst frequency exceeds a first threshold, assigning events to a Bayesian inference channel when the correlation entropy is lower than a second threshold, and assigning events to an ant colony completion channel when the events satisfy neither that the burst frequency exceeds the first threshold nor that the correlation entropy is lower than the second threshold;
Step 5: performing the following on attack chain fragments output by a parallel inference space through a multi-simulation verification system: physically replaying in a container cluster to generate a process behavior heat report, calculating instruction flow offsets and memory dirty data ratios based on system call baseline templates and outputting digital anomaly vectors, deploying a generative adversarial network to inject camouflaged attack events and generating an adversarial robustness score; and fusing the heat report, anomaly vectors, and robustness score through a meta-verifier to generate a comprehensive anti-interference index; and
Step 6: detecting a deviation between a physical replay and a digital model in the comprehensive anti-interference index, generating a weight adjustment coefficient γ when the deviation exceeds a preset tolerance, feeding back γ to the reinforcement learning controller in a closed loop to dynamically update loss function parameters, and feeding back γ to the dynamic routing engine to adjust a channel weight allocation strategy.

2. The method for constructing a backtracking analysis model based on an attack chain according to claim 1, wherein said generating event tuples comprises:
through the security agent, intercepting system call behaviors in a hardware-isolated environment, and extracting original features of the process creation behaviors, file access behaviors, and network connection behaviors;
in a differential privacy engine of the security agent, injecting differential noise into the original features according to a preset event type sensitivity matrix, and performing atomic operations for feature extraction and noise injection;
simultaneously retaining process parent-child relationship chains and file handle inheritance relationships in a process of noise injection to construct topology chains explicitly encoding attack causal dependencies; and
integrating noise-processed feature vectors, behavior fingerprints, and topology chains to generate structured event tuples comprising causal dependency chains.

3. The method for constructing a backtracking analysis model based on an attack chain according to claim 2, wherein generating the low-rank tensor block comprises:
receiving an input data stream from the event tuples in the tensor network processing pipeline
performing tensor space mapping operations to: encode the behavior fingerprints in the event tuples as 0th-order vectors of a tensor, process the noise feature vectors in the event tuples by Gram-Schmidt orthogonalization for filling to the 1st order, and convert the causal dependency chains in the event tuples into asymmetric adjacency tensors for storage in the 2nd order;
constructing a three-dimensional core tensor structure, wherein three orders of the three-dimensional core tensor structure respectively carry behavior type features, noise distribution attributes, and attack causal weights; and
decomposing the three-dimensional core tensor structure through a matrix product state model in the tensor network processing pipeline, and retaining the hidden variable subspaces with the singular values exceeding the preset threshold to generate the low-rank tensor block carrying spatio-temporal invariants.

4. The method for constructing a backtracking analysis model based on an attack chain according to claim 3, wherein the Step 2 comprises:
receiving to-be-corrected event timestamp sequences in the event tuples through a time correction module;
calculating the offsets of clocks of the slave nodes relative to the master node with a clock of the master node as a phase reference through a quantum phase estimation algorithm;
invoking the virtual quantum clocks to apply the phase rotation operations to the clocks of the slave nodes, and generating the synchronized event sequence eliminating clock drift;
inputting the synchronized event sequence into a low-rank tensor block construction process, and integrating time dimension attributes of the synchronized event sequence into time-axis coordinates of the hidden variable subspaces.

5. The method for constructing a backtracking analysis model based on an attack chain according to claim 4, wherein the Step 3 comprises:
inputting the low-rank tensor block into the reinforcement learning controller;
in the reinforcement learning controller, modeling the current attack chain as the directed acyclic graph with the security events as the nodes and the attack stage transition probabilities as the edges based on time dimension attributes of the low-rank tensor block;
calculating a connectivity loss value of event discarding operations to attack chain topology integrity, wherein the connectivity loss value L is quantified by a formula: L=1−(key path node retention rate×edge association strength), and the key path node retention rate is extracted from spatial dimension data of the low-rank tensor block; and
outputting the event importance score vector that generates high-risk markers for the privileged credential access nodes as a basis for constructing the risk-marked sampled event set.

6. The method for constructing a backtracking analysis model based on an attack chain according to claim 5, wherein the Step 4 comprises:
continuously monitoring tactical phase transition states of the security events in the reinforcement learning controller, and identifying stage jump events by comparing MITRE ATT&CK tactical labels in the attack behavior tensor block;
activating a feature reconstruction module to load corresponding time period events from an originally captured data stream of the host kernel layer when a stage jump is detected and privileged node-related events marked by the event importance score vector are missing;
processing the loaded events through a feature reconstruction algorithm to generate a reconstructed subset comprising markers for high-risk privileged nodes; and
merging the reconstructed subset with a current sampled event set to generate an updated sampled event set with dynamic risk markers for outputting to the dynamic routing engine.

7. The method for constructing a backtracking analysis model based on an attack chain according to claim 6, wherein the Step 4 further comprises:
receiving the updated sampled event set with dynamic risk markers through the dynamic routing engine;
constructing the gradient boosting decision tree model in the dynamic routing engine, taking risk marker features, event burst frequency, and correlation entropy in the updated sampled event set as input features;
calculating event allocation weights through the decision tree model to: assign events to the genetic path optimization channel when the event burst frequency exceeds a first preset threshold, assign events to the Bayesian inference channel when the event correlation entropy is lower than a second preset threshold, and weight events according to risk marking levels and assign the events to the ant colony completion channel when the events satisfy neither that the burst frequency exceeds the first threshold nor that the correlation entropy is lower than the second threshold; and
outputting classified three types of event sets to corresponding channels of the parallel inference space.

8. The method for constructing a backtracking analysis model based on an attack chain according to claim 7, wherein the Step 5 comprises:
receiving the classified three types of event sets output by the dynamic routing engine;
inputting the three types of event sets into the Bayesian inference channel, genetic path optimization channel, and ant colony completion channel for processing, respectively, generating path hypothesis fragments, and storing them in a shared memory pool;
activating the generative adversarial network to complete topological breakpoints in the path hypothesis fragments when inter-channel path consistency is lower than 90%; and
applying the completed path hypothesis fragments to generate an attack chain graph marked with optimization trajectories of each channel for outputting to the multi-simulation verification system.

9. The method for constructing a backtracking analysis model based on an attack chain according to claim 8, wherein the Step 5 further comprises:
receiving the attack chain graph through the multi-simulation verification system;
replaying an attack sequence in the attack chain graph in a container cluster, and generating the heat report by recording process behavior trajectories via kernel probes;
collecting instruction flow sequences during replay based on the system call baseline templates, calculating instruction flow Hamming distance offsets and memory page dirty data ratios, and outputting digital behavior anomaly index vectors;
deploying the generative adversarial network to inject temporally correlated camouflaged events into a replay system, and generating the adversarial robustness score based on misjudgment probability of a discriminant network for context semantics; and
fusing the heat report, anomaly index vectors, and robustness score through the meta-verifier to generate the comprehensive anti-interference index for outputting to a deviation correction module.

10. The method for constructing a backtracking analysis model based on an attack chain according to claim 9, wherein the Step 6 comprises:
fusing the process behavior heat report, digital behavior anomaly index vectors, and adversarial robustness score through the meta-verifier to generate the comprehensive anti-interference index;
detecting deviations between physical replay heat trajectories and digital model prediction trajectories based on three-dimensional verification data in the comprehensive anti-interference index;
generating the weight adjustment coefficient γ as a dynamic tuning factor when the deviations exceeds a preset tolerance threshold; and
feeding back γ to the reinforcement learning controller in a closed loop to update connectivity loss function parameters, and simultaneously feeding back γ to the dynamic routing engine to adjust the channel weight allocation strategy.
